(19) United States
(12) Patent Application Publication
(10) Pub. No.: US 2016/0130837 A1
(43) Pub. Date: May 12, 2016

(54) LOCK ASSEMBLY

(71) Applicant: TONG LUNG METAL INDUSTRY CO., LTD., Chiayi County (TW)

(72) Inventors: Ming-Shyang CHIOU, Chiaya City (TW); Kuang-I LIAO, Tainan City (TW)

(21) Appl. No.: 14/932,091

(22) Filed: Nov. 4, 2015

(30) Foreign Application Priority Data
Nov. 6, 2014 (TW) 103219622

(51) Int. Cl. E05B 3/00; E05B 1/00; E05B 15/00

(52) U.S. Cl. CPC E05B 3/003; E05B 15/00; E05B 1/0007

(57) ABSTRACT

A lock assembly includes a tube, a knob connected to the tube, a dismount mechanism including an engaging component that is movably disposed in the tube, and a lock unit mounted in the knob. The lock unit includes a rotor engaging the engaging component for preventing the lock unit from being dismounted. The rotor is rotatable between a first angular position, where the rotor prevents movement of the engaging component, and a second angular position, where the rotor allows the engaging component to move. The rotor is disengaged from the engaging component when the engaging component moves to a disengaging position, such that the lock unit can be dismounted from the knob.

### CROSS-REFERENCE TO RELATED APPLICATION

This application claims priority of Taiwanese Application No. 103219622, filed on Nov. 6, 2014.

### FIELD

This disclosure relates to a lock assembly, and more particularly to a lock assembly having a dismount mechanism.

### BACKGROUND

A conventional lock assembly for a door includes a latch, and two knob parts mounted to the door for operating the latch. Generally, an outer one of the knob parts includes a rose, a tube connected to the rose, an engaging component disposed in the tube, a knob connected to the tube by engaging the engaging component, and a lock unit mounted in the tube. The knob is formed with a tubular through hole, and the tube is received in the tubular through hole and is co-rotatable with the knob. The lock unit includes a rotor that has an exposed keyhole and that is operable through use of a key between a locking position and an unlocking position. In the unlocking position, the knob can be manipulated to drive the latch moving between an extension position and a retracted position. In the locking position, the knob is locked with the rose and cannot be manipulated, and movement of the engaging component is limited.

When it is required to replace the lock unit, the knob has to be disconnected from the tube first. In order to disconnect the knob from the tube, the rotor of the lock unit has to be in the unlocking position, and a special tool is used to push the engaging component so as to disengage the engaging component and the knob, such that the knob can be disconnected from the tube. Then, the lock unit can be taken out from the tube. Therefore, replacement of the lock unit is quite inconvenient.

### SUMMARY

Therefore, an object of this disclosure is to provide a lock assembly that can alleviate the aforesaid drawback of the prior art.

According to this disclosure, a lock assembly for a door includes a tube, a knob, a dismount mechanism and a lock unit.

The tube has an inner space and a through hole, and defines a central axis. The knob is connected to the tube, and has a mounting hole in spatial communication with the inner space of the tube. The lock unit is mounted in the mounting hole of the knob, and includes a rotor.

The dismount mechanism includes an engaging component disposed in the inner space of the tube, and a biasing component. The engaging component is movable in a transverse direction perpendicular to the central axis between an engaging position, where the engaging component extends out of the tube through the through hole and engages the rotor for preventing the lock unit from being dismounted from the knob, and a disengaging position, where the engaging component is disengaged from the rotor such that the lock unit can be dismounted from the knob along the central axis. The biasing component applies a biasing force to the engaging component to urge the engaging component toward the engaging position.

The rotor is rotatable through use of a unique key between a first angular position, where the rotor tightly engages the engaging component so as to prevent movement of the engaging component from the engaging position to the disengaging position, and a second angular position, where the rotor engages the engaging component with a gap therebetween allowing the engaging component to move from the engaging position to the disengaging position.

### BRIEF DESCRIPTION OF THE DRAWINGS

Other features and advantages of this disclosure will become apparent in the following detailed description of the embodiment with reference to the accompanying drawings, of which:

FIG. 1 is a perspective exploded view of an embodiment of a lock assembly according to this disclosure;

FIG. 2 is a perspective exploded view of a first knob part of the lock assembly;

FIG. 3 is another perspective exploded view of the first knob part for illustrating a dismount mechanism according to this disclosure;

FIG. 4 is a perspective view of an engaging component of the dismount mechanism according to this disclosure;

FIG. 5 is a perspective view of a lock unit;

FIG. 6 is a perspective exploded view for illustrating a knob together with the lock unit being dismounted;

FIG. 7 is a cross-sectional view of the knob and the lock unit for illustrating a rotor of the lock unit in a first angular position; and

FIG. 8 is another cross-sectional view of the knob and the lock unit for illustrating the rotor in a second angular position.

### DETAILED DESCRIPTION

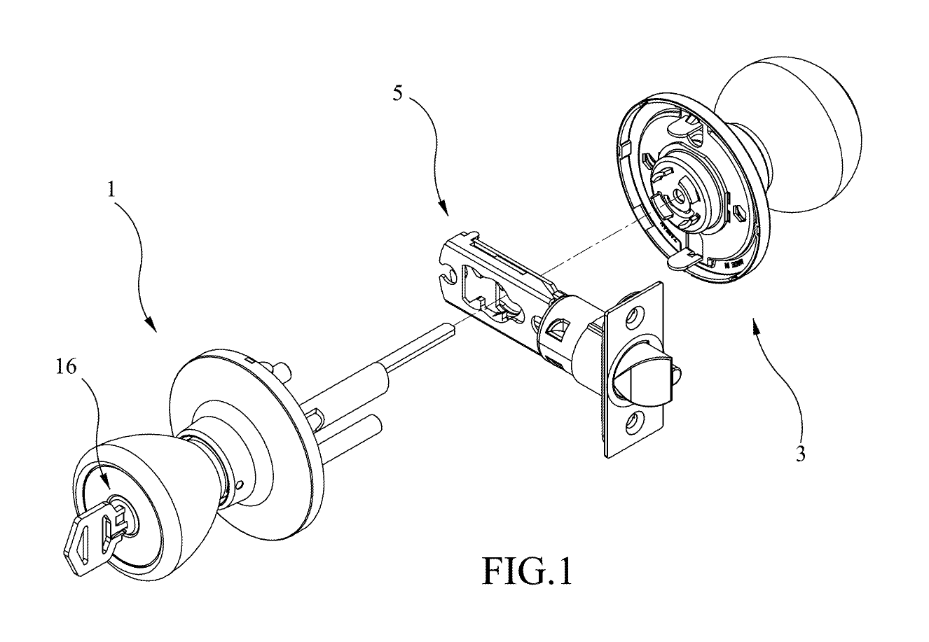

Referring to FIG. 1, an embodiment of a lock assembly according to this disclosure is configured to be mounted to a door (not shown), and includes a first knob part 1, a second knob part 3 and a latch 5. The first knob part 1 and the second knob part 3 are operatively connected to the latch 5, and are user-operable to drive the latch 5. For example, the first knob part 1 and the second knob part 3 are mounted to an outer side and an inner side of the door, respectively.

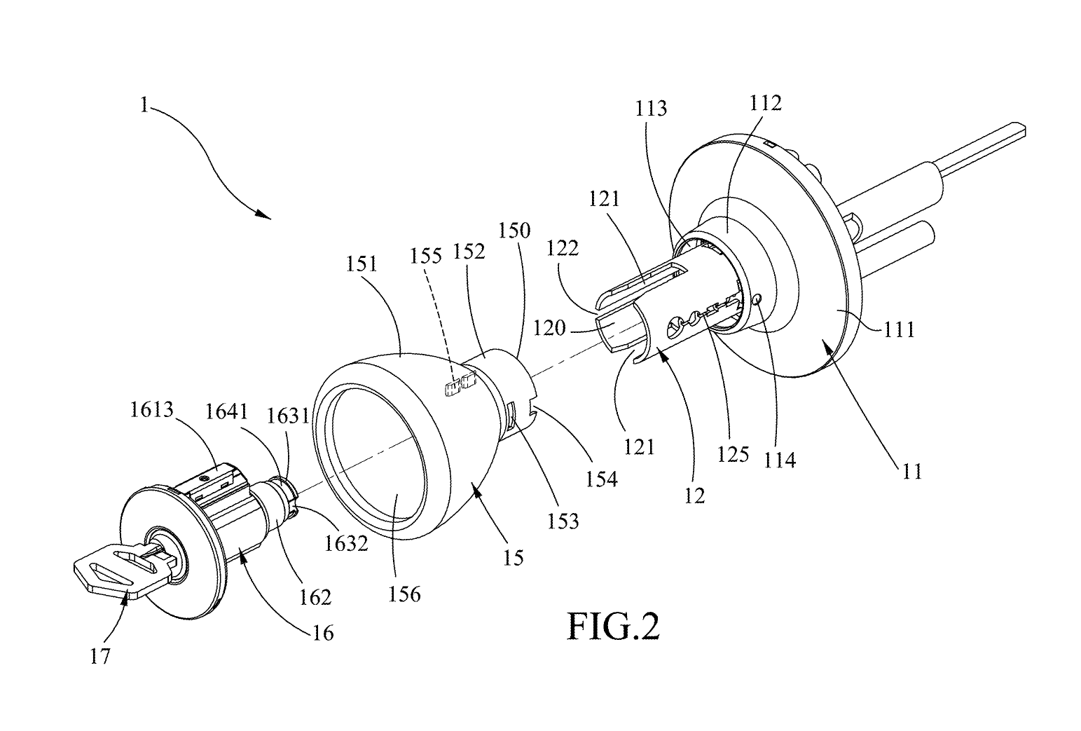

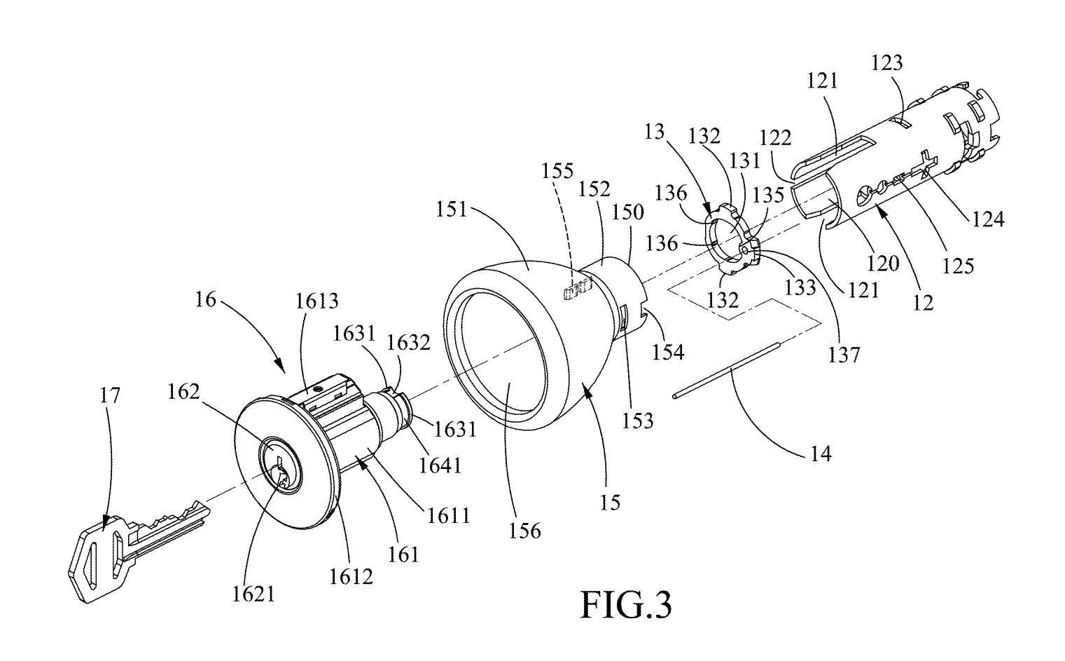

Referring to FIGS. 2 and 3, the first knob part 1 includes a rose 11, a tube 12, a dismount mechanism including an engaging component 13 and a biasing component 14, a knob 15, and a lock unit 16.

The rose 11 includes a plate 111 configured to be fixedly mounted to the door, and a surrounding wall 112 extending from the plate 111 and having a central through hole 113. The surrounding wall 112 is formed with a tool through hole 114 in spatial communication with the central through hole 113.

The tube 12 is rotatably mounted in the central through hole 113 of the rose 11. The tube 12 has an inner space 120, and defines a central axis. The tube 12 is formed with two elongate slots 121 and a guiding slot 122 that extend from one end of the tube 12 opposite to the rose 11, and two positioning holes 123 and a first through hole 124 that are disposed at a middle portion of the tube 12. The elongate slots 121 are diametrically opposite to each other, and the positioning holes 123 are aligned with the elongate slots 121, respectively. The first through hole 124 is angularly spaced apart from the positioning holes 123 by, for example, 90 degrees. The tube 12 includes a supporting part 125 close to and aligned with the first through hole 124 in an axial direction parallel to the central axis.

The knob 15 includes a handle segment 151, an insertion segment 152 connected to the handle segment 151, and a protrusion 155 projecting inwardly from an inner surface of the insertion segment 152. The knob 15 has a mounting hole 156 extending through the handle segment 151 and the insertion segment 152 along the central axis. The insertion segment 152 is formed with a second through hole 153 diametrically opposite to the protrusion 155, and has a distal end 150 formed with a notch 154. The notch 154 is aligned with the second through hole 153 in the axial direction. The knob 15 is connected to the tube 12, and the insertion segment 152 surrounds the tube 12. The mounting hole 156 is in spatial communication with the inner space 120 of the tube 12, and the second through hole 153 is aligned with the first through hole 124 and the tool through hole 114.

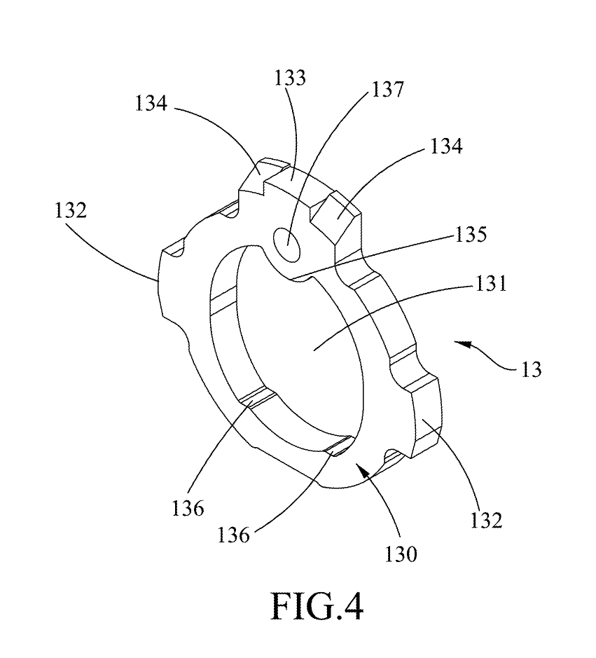

Further referring to FIG. 4, the engaging component 13 includes a ring body 130 having an outer circular surface, an inner circular surface and a central hole 131. The engaging component 13 further includes two positioning parts 132 and an engaging part 133 that extend outwardly from the outer circular surface with respect to the central axis, and a protrusion part 135 and two shoulders 136 that extend inwardly from the inner circular surface. The positioning parts 132 are diametrically opposite to each other. The engaging part 133 is disposed between the positioning parts 132, and has two lateral sides formed with two inclined planes 134, respectively. The protrusion part 135 is aligned with the engaging part 133. The shoulders 136 are opposite to the protrusion part 135, and are angularly spaced apart from each other. The ring body 130 is formed with an aperture 137 between the engaging part 133 and the protrusion part 135. The engaging component 13 is movably disposed in the inner space 120 of the tube 12, the positioning parts 132 are respectively inserted into the positioning holes 123, and the engaging part 133 is inserted into and engages the first through hole 124.

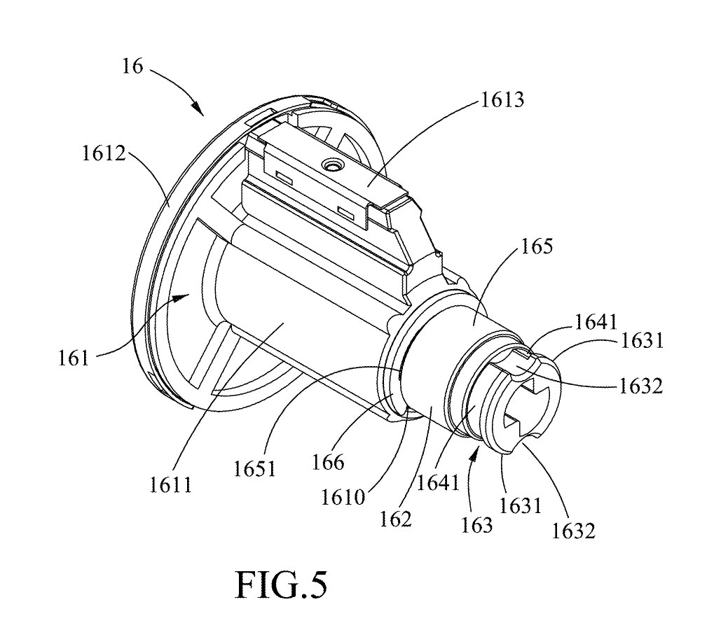

Further referring to FIG. 5, the lock unit 16 includes a lock housing 161 and a rotor 162. The lock housing 161 includes a tube body 1611 having a receiving space 1610, a plate portion 1612 connected to one end of the tube body 1611, and a protrusion portion 1613 projecting outwardly from the tube body 1611 and having one end connected to the plate portion 1612. The rotor 162 is mounted in the receiving space 1610, and has a key hole 1621 at one end. The rotor 162 is operable to switch between a lock state and an unlock state through use of a unique key 17 inserted into the key hole 1621. The lock unit 16 is mounted in the mounting hole 156 of the knob 15, and the mounting hole 156 is sufficiently large so as to allow the protrusion portion 1613 to pass therethrough and to allow the lock unit 16 to be dismounted directly from the knob 15.

The engaging component 13 is movable in a transverse direction perpendicular to the central axis among an engaging position, a disengaging position and a dismounting position. The disengaging position is between the engaging position and the dismounting position. In the engaging position, the engaging part 133 extends out of the tube 12 through the first through hole 124 and is inserted into and engages the first through hole 124 and the second through hole 153 so as to prevent the knob 15 from being dismounted from the tube 12, and the engaging component 13 engages the rotor 162 for preventing the lock unit 16 from being dismounted from the knob 15. In the disengaging position, the engaging component 13 is disengaged from the rotor 162 such that the lock unit 16 can be dismounted from the knob 15 along the central axis. In the dismounting position, the engaging part 133 retracts into the first through hole 124 and is disengaged from the second through hole 153 so as to allow separation of the knob 15 from the tube 12. The biasing component 14 is mounted to the supporting part 125 of the tube 12, and passes through the aperture 137 for applying a biasing force to the engaging component 13 to urge the engaging component 13 toward the engaging position.

The rotor 162 includes a first segment 163 and a second segment 165 that are arranged sequentially from the other end of the rotor 162 to said one end, which has the key hole 1621. The first segment 163 has two engaging grooves 1641, two projecting ribs 1631 and two low-lying grooves 1632. The engaging grooves 1641 partially surround the central axis, and are opposite to each other with respect to the central axis. The low-lying grooves 1632 partially surround the central axis, are opposite to each other with respect to the central axis, and are alternately arranged with the engaging grooves 1641. The engaging grooves 1641 are in spatial communication with the low-lying grooves 1632, and the low-lying grooves 1632 are deeper than the engaging grooves 1641. The projecting ribs 1631 project outwardly from the distal end of the rotor 162 and radially with respect to the central axis, extend respectively along the engaging grooves 1641, and are spaced apart from each other by the low-lying grooves 1632. The second segment 165 is formed with a circular groove 1651, and the rotor 162 further includes a snap ring 166 engaging the circular groove 1651 so as to limit movement of the rotor 162 with respect to the lock housing 161 in the axial direction.

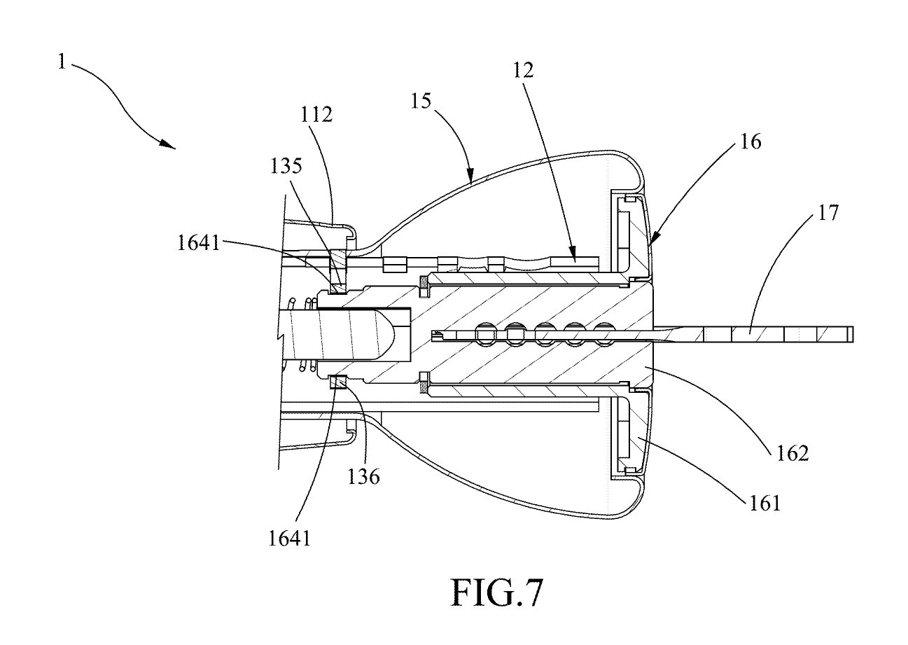

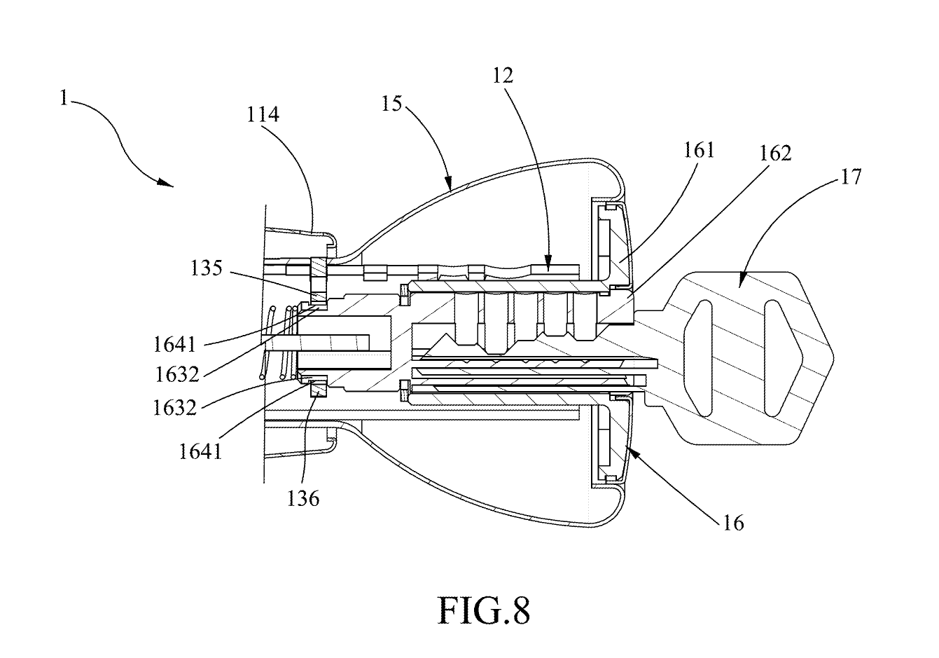

The rotor 162 is rotatable through use of the unique key 17 between a first angular position (see FIG. 7), where the rotor 162 tightly engages the engaging component 13 so as to prevent movement of the engaging component 13 from the engaging position to the disengaging position and the dismounting position, and a second angular position (see FIG. 8), where the rotor 162 engages the engaging component 13 with a gap therebetween allowing the engaging component 13 to move from the engaging position to the disengaging position and further to the dismounting position.

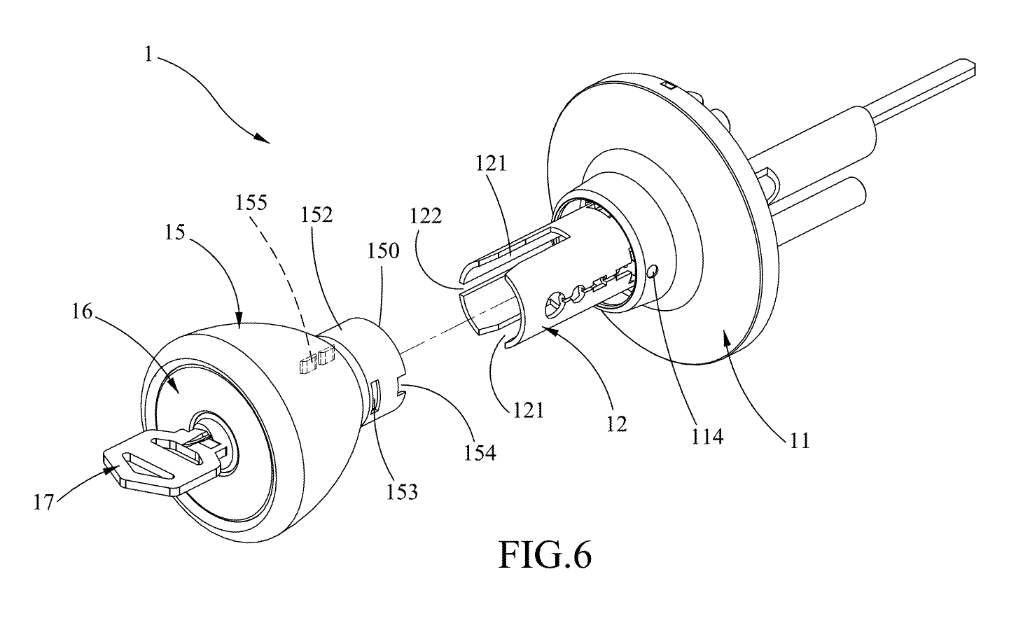

Referring to FIGS. 2 to 8, for assembling the first knob part 1 of the lock assembly of this embodiment, the insertion segment 152 of the knob 15 surrounds the tube 12, the knob 15 is moved toward the rose 11, and the protrusion 155 is slid along the guiding slot 122. The notch 154 is aligned with the engaging part 133 of the engaging component 13 that is placed in the inner space 120 of the tube 12, and two edges of the distal end 150 at the notch 154 push the inclined planes 134, respectively, such that the engaging part 133 is retracted and received in the insertion segment 152. Then, the knob 15 is continuously moved until the second through hole 153 is aligned with the first through hole 124 as well as the tool through hole 114. At this time, the biasing component 14 provides the biasing force to the engaging component 13 to urge the engaging component 13 toward the engaging position, and the engaging part 133 is inserted into and engages the first through hole 124 and the second through hole 153, connecting the knob 15 to the tube 12.

Then, the rotor 162 is rotated, through use of the unique key 17 inserted into the keyhole 1621, from the first angular position (FIG. 7) to the second angular position (FIG. 8) by a predetermined angle of, for example, 90 degrees, and the lock unit 16 is inserted into the mounting hole 156 of the knob 15. The protrusion portion 1613 of the lock housing 161 is received in one of the elongate slots 121, and one of the low-lying grooves 1632 is aligned with the protrusion part 135 of the engaging component 13. At this time, an edge of each of the projecting ribs 1631 that is adjacent to the other one of the low-lying grooves 1632 abuts against a respective one of the shoulders 136. Then, a tool passing through the tool through hole 114 is used to push the engaging part 133, and the engaging component 13 is moved in the transvers direction from the engaging position to the disengaging position, such that the lock unit 16 can be entirely inserted into the mounting hole 156 and each of the shoulders 136 is aligned with an edge of a respective one of the engaging grooves 1641 that is adjacent to said the other one of the low-lying grooves. Subsequently, the engaging part 133 is released, and the engaging component 13 returns to the engaging position due to the biasing force provided by the biasing component 14. In the engaging position, the shoulders 136 tightly and respectively engage the edge of the engaging grooves 1641, and respectively abut against the projecting ribs 1631, such that the lock unit 16 cannot be dismounted from the knob 15.

When the rotor 162 is rotated to the first angular position, the protrusion part 135 tightly engages one of the engaging grooves 1641, and the shoulders 136 tightly engage the other one of the engaging grooves 1641 and abut against one of the projecting ribs 1631 that corresponds to said other one of the engaging grooves 1641. As a result, movement of the engaging component 13 from the engaging position to the disengaging position is prevented, and the lock unit 16 cannot be dismounted.

For dismounting the lock unit 16, the rotor 162 is rotated through use of the unique key 17 inserted into the key hole 1621 from the first angular position to the second angular position. Accordingly, the protrusion part 135 faces one of the low-lying grooves 1632 and has the gap therebetween, and the shoulders 136 abut against the edges of the projecting ribs 1631 that are adjacent to the other one of the low-lying grooves 1632, respectively. Then, the tool is inserted into the tool through hole 114, and pushes the engaging part 133 so as to move the engaging component 13 to the disengaging position. In the disengaging position, the protrusion part 135 is partially accommodated in said one of the low-lying grooves 1632, and the shoulders 136 separate from the edges of the projecting ribs 1631. As a result, the lock unit 16 can be dismounted from the knob 15 along the central axis.

When the tool further pushes the engaging part 133 to move the engaging component 13 in the transverse direction to the dismounting position, the engaging part 133 is disengaged from the second through hole 153 and retracts into the first through hole 124, such that the knob 15 can be separated from the tube 12. In other embodiments, the knob 15 can be riveted to the tube 12, and only the lock unit 16 can be dismounted.

In conclusion, when the lock unit 16 requires replacement, the lock unit 16 can be easily dismounted without separating the knob 15 from the tube 12.

While this disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A lock assembly for a door, comprising:
a tube having an inner space and a through hole, and defining a central axis;
a knob connected to said tube, and having a mounting hole in spatial communication with said inner space of said tube;
a lock unit mounted in said mounting hole of said knob, and including a rotor; and
a dismount mechanism including
an engaging component disposed in said inner space of said tube, and being movable in a transverse direction perpendicular to the central axis between an engaging position, where said engaging component extends out of said tube through said through hole and engages said rotor for preventing said lock unit from being dismounted from said knob, and a disengaging position, where said engaging component is disengaged from said rotor such that said lock unit can be dismounted from said knob along the central axis, and
a biasing component applying a biasing force to said engaging component to urge said engaging component toward the engaging position,
wherein said rotor is rotatable through use of a unique key between a first angular position, where said rotor tightly engages said engaging component so as to prevent movement of said engaging component from the engaging position to the disengaging position, and a second angular position, where said rotor engages said engaging component with a gap therebetween allowing said engaging component to move from the engaging position to the disengaging position.

2. The lock assembly as claimed in claim 1, wherein said engaging component includes a ring body surrounding said rotor and having an inner circular surface, and a protrusion part extending inwardly from said inner circular surface of said ring body, and
wherein said rotor of said lock unit is formed with an engaging groove that engages said protrusion part when said rotor is in the first angular position.

3. The lock assembly as claimed in claim 2, wherein said engaging component further includes a shoulder extending inwardly from said inner circular surface of said ring body and opposite to said protrusion part, and said rotor includes a projecting rib that projects outwardly and radially with respect to the central axis, and
wherein said projecting rib abuts against said shoulder for preventing movement of said lock unit along the central axis when said rotor is in the first angular position.

4. The lock assembly as claimed in claim 3, wherein said rotor is further formed with a low-lying groove that faces said protrusion part when said rotor is in the second angular position, and said protrusion part is partially accommodated in said low-lying groove and said shoulder separates from said projecting rib when said engaging component is pushed to the disengaging position.

5. The lock assembly as claimed in claim 4, wherein said engaging groove is in spatial communication with said low-lying groove, and said low-lying groove is deeper than said engaging groove.

6. The lock assembly as claimed in claim 1, wherein said engaging component includes:
a ring body surrounding said rotor, and having an outer circular surface and an inner circular surface;
an engaging part extending outwardly from said outer circular surface;
a protrusion part extending inwardly from said inner circular surface and aligned with said engaging part; and
two shoulders extending inwardly from said inner circular surface, opposite to said protrusion part, and angularly spaced apart from each other.

7. The lock assembly as claimed in claim 6, wherein said engaging component is further movable in the transverse direction from the disengaging position to a dismounting position, and said engaging part extends out of said tube through said through hole and engages said knob so as to prevent said knob from being dismounted from said tube when said engaging component is in the engaging position and the disengaging position, and retracts into said through hole and is disengaged from said knob so as to allow separation of said knob from said tube when said engaging component is in the dismounting position.

8. The lock assembly as claimed in claim 6, wherein said rotor of said lock unit has:
two engaging grooves partially surrounding the central axis and opposite to each other with respect to the central axis;
two low-lying grooves partially surrounding the central axis, being opposite to each other with respect to the central axis, alternately arranged with said engaging grooves, and being in spatial communication with said engaging grooves; and
two projecting ribs projecting outwardly and radially with respect to the central axis, extending respectively along said engaging grooves, and being spaced apart from each other by said low-lying grooves.

9. The lock assembly as claimed in claim 8, wherein, when said rotor is in the first angular position, said protrusion part engages one of said engaging grooves, and said shoulders engage the other one of said engaging grooves,
wherein, when said rotor is rotated to the second angular position, said protrusion part faces one of said low-lying grooves and has the gap therebetween, and each of said shoulders engages an edge of a respective one of said engaging grooves that is adjacent to the other one of said low-lying grooves, and
wherein, when said rotor is in the second angular position and said engaging component is moved to the disengaging position, said protrusion part is partially accommodated in said one of said low-lying grooves, and each of said shoulders is disengaged from said edge of said respective one of said engaging grooves and separates from a corresponding one of said projecting ribs that extends along said one of said engaging grooves.

10. The lock assembly as claimed in claim 1, wherein said mounting hole of said knob is sufficiently large so as to allow said lock unit to be dismounted from said knob.

11. A lock assembly for a door, comprising:
a tube having an inner space and a through hole, and defining a central axis;
a knob connected to said tube, and having a mounting hole in spatial communication with said inner space of said tube;
a lock unit mounted in said mounting hole of said knob, and including a rotor that is rotatable through use of a unique key between a first angular position and a second angular position, and that is formed with an engaging groove and a low-lying groove partially surrounding the central axis and being in spatial communication with each other, said low-lying groove being deeper than said engaging groove; and
a dismount mechanism including
an engaging component that is disposed in said inner space of said tube, and that includes a ring body surrounding said rotor, said ring body having an inner circular surface and a protrusion part extending inwardly from said inner circular surface, said engaging component being movable in a transverse direction perpendicular to the central axis between an engaging position, where said engaging component extends out of said tube through said through hole and engages said engaging groove for preventing said lock unit from being dismounted from said knob, and a disengaging position, where said engaging component is disengaged from said engaging groove such that said lock unit can be dismounted from said knob along the central axis, and
a biasing component that applies a biasing force to said engaging component to urge said engaging component toward the engaging position,
wherein said protrusion part tightly engages said engaging groove so as to prevent movement of said engaging component from the engaging position to the disengaging position when said rotor is in the first angular position, and faces said low-lying groove and has a gap therebetween allowing said engaging component to move from the engaging position to the disengaging position when said rotor is in the second angular position.

12. The lock assembly as claimed in claim 11, wherein said engaging component further includes a shoulder extending inwardly from said inner circular surface of said ring body and opposite to said protrusion part, and said rotor includes a projecting rib that projects outwardly and radially with respect to the central axis, and
wherein said projecting rib abuts against said shoulder for preventing movement of said lock unit along the central axis when said rotor is in the first angular position.

13. The lock assembly as claimed in claim 12, wherein, when said rotor is in the second angular position, an edge of said projecting rib that is opposite to said low-lying groove abuts against said shoulder while said engaging component is in the engaging position, and said protrusion part is partially accommodated in said low-lying groove and said shoulder separates from said projecting rib such that said lock unit can be dismounted from said knob along the central axis while said engaging component is pushed to the disengaging position.

14. The lock assembly as claimed in claim 11, wherein said ring body of said engaging component further has an outer circular surface, and said engaging component further includes an engaging part extending outwardly from said outer circular surface and aligned with said protrusion part, and two shoulders extending inwardly from said inner circular surface, opposite to said protrusion part, and angularly spaced apart from each other.

15. The lock assembly as claimed in claim 14, wherein said engaging component is further movable in the transverse direction from the disengaging position to a dismounting position, and said engaging part extends out of said tube through said through hole and engages said knob so as to prevent said knob from being dismounted from said tube when said engaging component is in the engaging position and the disengaging position, and retracts into said through hole and is disengaged from said knob so as to allow separation of said knob from said tube when said engaging component is in the dismounting position.

16. The lock assembly as claimed in claim 14, wherein said rotor of said lock unit has:
two of said engaging grooves partially surrounding the central axis and opposite to each other with respect to the central axis;
two of said low-lying grooves partially surrounding the central axis, being opposite to each other with respect to the central axis, alternately arranged with said engaging grooves, and being in spatial communication with said engaging grooves; and
two projecting ribs projecting outwardly and radially with respect to the central axis, extending respectively along said engaging grooves, and being spaced apart from each other by said low-lying grooves.

17. The lock assembly as claimed in claim 16, wherein, when said rotor is in the first angular position, said protrusion part engages one of said engaging grooves, and said shoulders engage the other one of said engaging grooves,
wherein, when said rotor is rotated to the second angular position, said protrusion part faces one of said low-lying grooves and has the gap therebetween, and each of said shoulders engages an edge of a respective one of said engaging grooves that is adjacent to the other one of said low-lying grooves, and
wherein, when said rotor is in the second angular position and said engaging component is moved to the disengaging position, said protrusion part is partially accommodated in said one of said low-lying grooves, and each of said shoulders is disengaged from said edge of said respective one of said engaging grooves and separates from a corresponding one of said projecting ribs that extends along said one of said engaging grooves.

18. The lock assembly as claimed in claim 11, wherein said mounting hole of said knob is sufficiently large so as to allow said lock unit to be dismounted from said knob.

19. A lock assembly for a door, comprising:
a tube having an inner space and a through hole, and defining a central axis;
a knob connected to said tube, and having a mounting hole in spatial communication with said inner space of said tube;
a dismount mechanism including
an engaging component that is disposed in said inner space of said tube, that is movable in a transverse direction perpendicular to the central axis between an engaging position and a disengaging position, and that includes a ring body having an inner circular surface, a protrusion part extending inwardly from said inner circular surface, and two shoulders extending inwardly from said inner circular surface and opposite to said protrusion part, said shoulders being angularly spaced apart from each other, and
a biasing component that applies a biasing force to said engaging component to urge said engaging component toward the engaging position; and
a lock unit mounted in said mounting hole of said knob, and including a rotor that is surrounded by said ring body and engages said engaging component for preventing said lock unit from being dismounted from said knob, that is rotatable through use of a unique key between a first angular position and a second angular position, and that has
two engaging grooves partially surrounding the central axis and opposite to each other with respect to the central axis;
two low-lying grooves partially surrounding the central axis, being opposite to each other with respect to the central axis, alternately arranged with said engaging grooves, and being in spatial communication with said engaging grooves, and
two projecting ribs projecting outwardly and radially with respect to the central axis, extending respectively along said engaging grooves, and being spaced apart from each other by said low-lying grooves,
wherein said engaging component extends out of said tube through said through hole and engages said engaging grooves for preventing said lock unit from being dismounted from said knob when said engaging component is in the engaging position, and is disengaged from said engaging grooves such that said lock unit can be dismounted from said knob along the central axis when said engaging component is in the disengaging position,
wherein, when said rotor is in the first angular position, said protrusion part tightly engages one of said engaging grooves, and said shoulders engage the other one of said engaging grooves,
wherein, when said rotor is rotated to the second angular position, said protrusion part faces one of said low-lying grooves and has a gap therebetween allowing said engaging component to move from the engaging position to the disengaging position, and each of said shoulders engages an edge of a respective one of said engaging grooves that is adjacent to the other one of said low-lying grooves, and
wherein, when said rotor is in the second angular position and said engaging component is moved to the disengaging position, said protrusion part is partially accommodated in said one of said low-lying grooves, and each of said shoulders is disengaged from said edge of said respective one of said engaging grooves and separates from a corresponding one of said projecting ribs that extends along said one of said engaging grooves, such that said lock unit can be dismounted from said knob along the central axis.

20. The lock assembly as claimed in claim 19, wherein said mounting hole of said knob is sufficiently large so as to allow said lock unit to be dismounted from said knob.
